(19) United States
(12) Patent Application Publication
(10) Pub. No.: US 2026/0136351 A1
(43) Pub. Date: May 14, 2026

(54) FEEDBACK METHOD AND DEVICE FOR SEMI-PERSISTENT SCHEDULING DEACTIVATION, AND STORAGE MEDIUM

(71) Applicant: Beijing Xiaomi Mobile Software Co., Ltd., Beijing (CN)

(72) Inventors: Xuemei QIAO, Beijing (CN); Qin MU, Beijing (CN)

(73) Assignee: Beijing Xiaomi Mobile Software Co., Ltd., Beijing (CN)

(21) Appl. No.: 19/120,070

(22) PCT Filed: Oct. 11, 2022
(86) PCT No.: PCT/CN2022/124725

§ 371 Date: Apr. 10, 2025

(51) Int. Cl. H04W 72/11; H04L 5/00; H04L 27/26; H04W 72/231; H04W 72/51

(52) U.S. Cl. CPC H04W 72/11; H04L 5/0053; H04L 27/26025; H04W 72/231; H04W 72/51

(57) ABSTRACT

A feedback method for semi-persistent scheduling (SPS) deactivation, including: receiving downlink control information for the semi-persistent scheduling deactivation sent by a base station via a physical downlink control channel; and sending acknowledge feedback after a first number of symbol intervals in response to receiving a last symbol of the downlink control information; where the first number of symbol intervals is a number of symbols corresponding to a minimum feedback delay of the terminal, and in a case where a subcarrier spacing of the physical downlink control channel is the same, different minimum feedback delays correspond to terminals having at least one of different channel processing capabilities or different signal processing capabilities.

### CROSS-REFERENCE TO RELATED APPLICATION

The present application is a U.S. National Stage of International Application No. PCT/CN 2022/124725, filed on Oct. 11, 2022, the contents of all of which are incorporated herein by reference in their entireties for all purposes.

### BACKGROUND OF THE INVENTION

A possible way to reduce implementation complexity of a terminal and save cost of the terminal is to relax a physical downlink shared channel (PDSCH)/physical uplink shared channel (PUSCH) processing delay of the terminal in the related art. For example, the PDSCH processing delay of the terminal is relaxed to twice an original value. Because the value of the PDSCH processing delay is partially derived from a blind detection delay of a physical downlink control channel (PDCCH), the blind detection delay of the PDCCH is relaxed too while the PDSCH processing delay is relaxed.

### SUMMARY OF THE INVENTION

The present disclosure relates to the field of communication, and in particular to a feedback method and device for semi-persistent scheduling deactivation, and a storage medium.

According to a first aspect of an embodiment of the present disclosure, a feedback method for semi-persistent scheduling deactivation is provided. The method is performed by a terminal, and includes: receiving downlink control information for the semi-persistent scheduling deactivation sent by a base station via a physical downlink control channel; and sending acknowledge feedback after a first number of symbol intervals in response to receiving a last symbol of the downlink control information; and where the first number of symbol intervals is a number of symbols corresponding to a minimum feedback delay of the terminal, and in a case where a subcarrier spacing of the physical downlink control channel is the same, different minimum feedback delays correspond to terminals having at least one of different channel processing capabilities or different signal processing capabilities.

According to a second aspect of an embodiment of the present disclosure, a feedback method for semi-persistent scheduling deactivation is provided. The method is performed by a base station, and includes: sending downlink control information for the semi-persistent scheduling deactivation to a terminal via a physical downlink control channel, where the downlink control information is configured to indicate the terminal to send acknowledge feedback; and receiving the acknowledge feedback sent by the terminal, where the terminal sends the acknowledge feedback after a first number of symbol intervals in response to receiving a last symbol of the downlink control information; and where the first number of symbol intervals is a number of symbols corresponding to a minimum feedback delay of the terminal, and in a case where a subcarrier spacing of the physical downlink control channel is the same, different minimum feedback delays correspond to terminals having at least one of different channel processing capabilities or different signal processing capabilities.

According to a third aspect of an embodiment of the present disclosure, a feedback device for semi-persistent scheduling deactivation is provided. The device includes: one or more processors; and a memory that stores processor-executable instructions. Where the one or more processors are collectively configured to: receive downlink control information for the semi-persistent scheduling deactivation sent by a base station via a physical downlink control channel; and send acknowledge feedback after a first number of symbol intervals in response to receiving a last symbol of the downlink control information. Where the first number of symbol intervals is a number of symbols corresponding to a minimum feedback delay of the terminal, and in a case where a subcarrier spacing of the physical downlink control channel is the same, different minimum feedback delays correspond to terminals having at least one of different channel processing capabilities or different signal processing capabilities.

According to a fourth aspect of an embodiment of the present disclosure, a feedback device for semi-persistent scheduling deactivation is provided. The device includes: one or more processors; and a memory that stores processor-executable instructions. Where the one or more processors are collectively configured to: send downlink control information for the semi-persistent scheduling deactivation to a terminal via a physical downlink control channel, where the downlink control information is configured to indicate the terminal to send acknowledge feedback; and receive the acknowledge feedback sent by the terminal, where the terminal sends the acknowledge feedback after a first number of symbol intervals in response to receiving a last symbol of the downlink control information. Where the first number of symbol intervals is a number of symbols corresponding to a minimum feedback delay of the terminal, and in a case where a subcarrier spacing of the physical downlink control channel is the same, different minimum feedback delays correspond to terminals having at least one of different channel processing capabilities or different signal processing capabilities.

According to a fifth aspect of an embodiment of the present disclosure, a non-transitory computer-readable storage medium is provided. The non-transitory computer-readable storage medium stores computer program instructions, where the program instructions, when executed by one or more processors, implement steps of the method according to any one of the first aspect or steps of the method according to any one of the second aspect.

It should be understood that the above general description and the following detailed description are merely illustrative and explanatory, and cannot limit the present disclosure.

### BRIEF DESCRIPTION OF DRAWINGS

The above and/or additional aspects and benefit of the present disclosure will become apparent and easy to understand from the following description of the embodiments in combination with the accompanying drawings.

FIG. 1A is a schematic diagram of a network system architecture to which an embodiment of the present disclosure is applicable.

FIG. 1B is a schematic diagram of another network system architecture to which an embodiment of the present disclosure is applicable.

FIG. 2 is a flowchart of a feedback method for the semi-persistent scheduling deactivation shown according to an example.

FIG. 3 is a flowchart of a feedback method for the semi-persistent scheduling deactivation shown according to an example.

FIG. 4 is a flowchart of a feedback method for the semi-persistent scheduling deactivation shown according to an example.

FIG. 5 is a flowchart of a feedback method for the semi-persistent scheduling deactivation shown according to an example.

FIG. 6 is a flowchart of a feedback method for the semi-persistent scheduling deactivation shown according to an example.

FIG. 7 is a flowchart of a feedback method for the semi-persistent scheduling deactivation shown according to an example.

FIG. 8 is an interaction diagram of a feedback method for the semi-persistent scheduling deactivation shown according to an example.

FIG. 9 is a block diagram of a feedback device for the semi-persistent scheduling deactivation shown according to an example.

FIG. 10 is a block diagram of a feedback device for the semi-persistent scheduling deactivation shown according to an example.

FIG. 11 is a block diagram of a feedback device for the semi-persistent scheduling deactivation shown according to an example.

FIG. 12 is a block diagram of a feedback device for the semi-persistent scheduling deactivation shown according to an example.

### DETAILED DESCRIPTION OF THE INVENTION

The examples will be described in detail here and their instances are illustratively shown in the accompanying drawings. When the following descriptions relate to the accompanying drawings, unless otherwise specified, the same numeral in different accompanying drawings denotes the same or similar element. The implementations described in the following examples do not denote all implementations consistent with the present disclosure. On the contrary, the implementations are merely examples of a device and a method consistent with some aspects of the present disclosure as detailed in the appended claims.

A possible way to reduce implementation complexity of a terminal and save cost of the terminal is to relax a physical downlink shared channel (PDSCH)/physical uplink shared channel (PUSCH) processing delay of the terminal in the related art. For example, the PDSCH processing delay of the terminal is relaxed to twice an original value. Because the value of the PDSCH processing delay is partially derived from a blind detection delay of a physical downlink control channel (PDCCH), the blind detection delay of the PDCCH is relaxed too while the PDSCH processing delay is relaxed. However, if a relaxed processing capability is introduced to the terminal, it is no longer appropriate to schedule feedback for semi-persistent scheduling (SPS) deactivation of the terminal based on a traditional delay requirement. In view of that, how to ensure that the terminal is able to successfully send acknowledge feedback for SPS release becomes a pressing issue.

In order to solve the above technical problem, the present disclosure provides a feedback method and device for semi-persistent scheduling deactivation, and a storage medium.

An implementation environment of an embodiment of the present disclosure is firstly introduced below.

The embodiment of the present disclosure is applicable to a fourth generation mobile communication system (4G) evolution system such as a long term evolution (LTE) system, or a fifth generation mobile communication system (5G) such as an access network using a new radio access technology (New RAT); and a communication system such as a cloud radio access network (CRAN).

FIG. 1A illustratively shows a schematic diagram of a system architecture to which an embodiment of the present disclosure is applicable. It should be understood that the embodiment of the present disclosure is not limited to a system shown in FIG. 1A. Moreover, a device shown in FIG. 1A may be hardware, software divided from functions, or a structure combining the hardware and the software. As shown in FIG. 1A, the system architecture according to the embodiment of the present disclosure includes a terminal 10, a base station 20, a mobility management network element 30, a session management network element 40, a user plane network element 50 and a data network (DN) 60. The terminal 10 communicates with the DN 60 via the base station 20 and the user plane network element 50.

The network elements shown in FIG. 1A may be in a 4G architecture or in a 5G architecture.

The data network (DN) provides a data transmission service for a user, and may be a protocol data unit (PDN) network, such as internet and internet protocol (IP) multi-media service (IMS).

With reference to a schematic diagram of a system architecture of a 5G shown in FIG. 1B, a mobility management network element may include an access and mobility management function (AMF) 31 in the 5G. The mobility management network element is responsible for access and mobility management of a terminal in a mobile network. The AMF 31 is responsible for terminal access and mobility management, non-access stratum (NAS) message routing, session management function (SMF) selection, etc. The AMF 31 as an intermediate network element may be used to transmit a session management message between the terminal and an SMF.

A session management network element is responsible for forwarding path management. For example, the session management network element delivers a message forwarding policy to a user plane network element and indicates the user plane network element to process and forward a message according to the message forwarding policy. The session management network element may be the SMF 41 in the 5G (as shown in FIG. 1B), and is responsible for session management, such as session creation/modification/deletion, user plane network element selection, and allocation and management of user plane tunnel information.

The user plane network element may be a user plane function (UPF) 51 in a 5G architecture, as shown in FIG. 1B. The UPF 51 is responsible for message processing and forwarding.

The system architecture according to the embodiment of the present disclosure may further include a data management network element. The data management network element is used for terminal device identity processing, access authentication, registration, mobility management, etc. In the 5G communication system, the data management network element may be a unified data management (UDM) network element.

The system architecture according to the embodiment of the present disclosure may further include a policy control function (PCF) or a policy and charging control function (PCRF). The PCF or the PCRF is responsible for policy control decision and flow-based charging control.

The system architecture according to the embodiment of the present disclosure may further include a network storage network element. The network storage network element is used to maintain real-time information of all network function services in a network. In the 5G communication system, the network storage network element may be a network repository function (NRF) network element. The network repository function network element may store information of a number of network elements, such as SMF information, UPF information and AMF information. AMF, SMF, UPF and other network elements may be connected to the NRF in the network. On one hand, network element information of the network elements may be registered to the NRF. On the other hand, other network elements may obtain information of registered network elements from the NRF. Other network elements (for example, the AMF) may obtain optional network elements by requesting the NRF according to a network element type, a data network identity, unknown area information, etc. If a domain name system (DNS) server is integrated in the NRF, a corresponding selection function network element (for example, the AMF) may request the NRF to obtain other network elements (for example, the SMF) to be selected.

As a specific implementation form of an access network (AN) 21, the base station may also be referred to as an access node. If the base station is in a form of radio access, the base station may be referred to as a radio access network (RAN). As shown in FIG. 1B, the base station provides a radio access service for the terminal. The access node may be specifically a base station in a global system for mobile communication (GSM) or in a code division multiple access (CDMA) system, a node B (NodeB) in a wideband code division multiple access (WCDMA) system, an evolutional node B (eNB or eNodeB) in an LTE system, or a base station device, a small base station device, a wireless fidelity access point (WiFiAP), a worldwide interoperability for microwave access base station (WiMAX BS), etc. in a 5G network, which is not limited in the present disclosure.

The terminal may also be referred to as an access terminal, user equipment (UE) 11, a subscriber unit, a subscriber station, a mobile station, a mobile, a remote station, a remote terminal, a mobile device, a user terminal, a wireless communication device, a user agent or a user device. In FIG. 1B, the UE 11 is described as an example. The terminal may be a cellular telephone, a cordless telephone, a session initiation protocol (SIP) telephone, a wireless local loop (WLL) station, a personal digital assistants (PDA), a handheld or a computing device having a wireless communication function, or other processing devices, a vehicle-mounted device, a wearable device, and an Internet of Things terminal device connected to a wireless modem, such as a fire detection sensor, a smart water meter/electric meter and a factory monitoring device.

The functions described above may be network elements in a hardware device, software functions running on dedicated hardware, or virtualization functions instantiated on a platform (for example, a cloud platform).

Further, the terms involved in the embodiment according to the present disclosure are further supplemented in the present application.

Semi-persistent scheduling (SPS): a novel scheduling method-semi-persistent scheduling (SPS) is introduced in a third generation partnership project (3GPP). In the semi-persistent scheduling, system resources (including uplink resources and downlink resources) merely need to be allocated or specified once via a PDCCH, and then the same time-frequency resources may be periodically reused.

Reduced capability (RedCap): a 5G technology defined by a 3GPP standardization organization, which belongs to a new technology standard NR light (NR lite). For a number of application scenarios, a speed requirement is medium, a performance requirement is medium, a power consumption requirement is medium, and a cost requirement is medium. For these requirements, performance and cost are balanced, and these requirements may further coexist with 5G network deployment. RedCap emerges from the requirements. An eRedCap may refer to an enhanced reduced capability terminal, i.e. a terminal whose capability further be reduced based on a RedCap terminal.

Downlink control information (DCI) is carried by the PDCCH. Downlink control information sent by the eNB to the terminal includes uplink and downlink resource allocation, HARQ information, power control, etc.

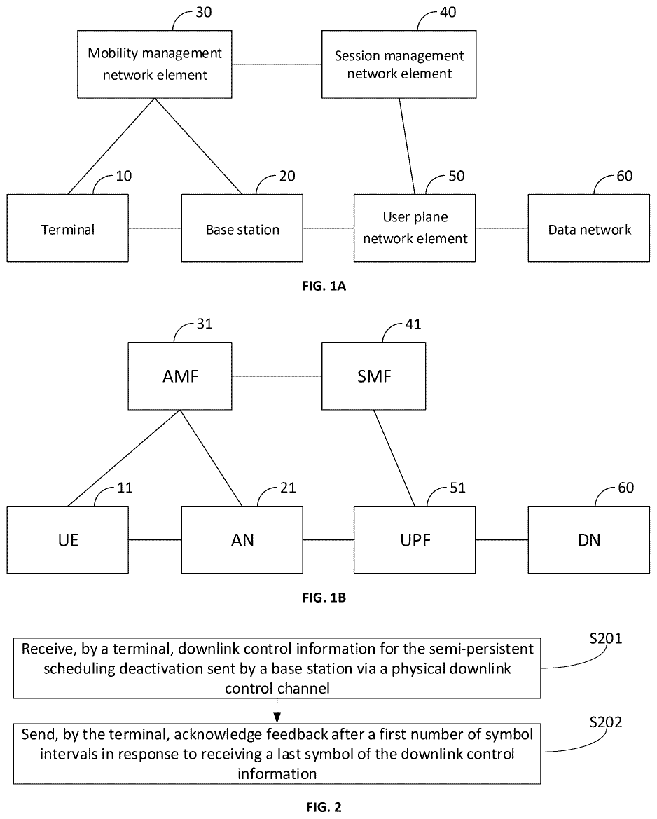

FIG. 2 is a flowchart of a feedback method for semi-persistent scheduling deactivation shown according to an example. The method is performed by a terminal. As shown in FIG. 2, the method includes following steps S201-S202.

S201, downlink control information for the semi-persistent scheduling deactivation sent by a base station via a physical downlink control channel is received by the terminal.

S202, acknowledge feedback is sent by the terminal after a first number of symbol intervals in response to receiving a last symbol of the downlink control information.

The first number of symbol intervals is a number of symbols corresponding to a minimum feedback delay of the terminal, and in a case where a subcarrier spacing of the physical downlink control channel is the same, different minimum feedback delays correspond to terminals having different signal processing capabilities.

The acknowledge feedback may be acknowledge character (ACK) feedback. Specifically, acknowledge information may be carried via hybrid automatic repeat request-acknowledgement (HARQ-ACK).

The minimum feedback delay in the embodiment of the present disclosure may be minimum duration between receiving the last symbol of the DCI for SPS deactivation and sending a first symbol of the ACK feedback by the terminal.

In some possible implementations, the minimum feedback delay is predefined based on a communication protocol and a terminal processing capability, and it is predetermined in the communication protocol that different minimum feedback delays correspond to terminals having different signal processing capabilities in a case where a subcarrier spacing of a physical downlink control channel is the same. In some examples, the same minimum feedback delays may correspond to the terminals having the same signal processing capability in a case where the subcarrier spacing of the physical downlink control channel is the same.

In some possible implementations, different minimum feedback delays may correspond to terminals having the same signal processing capability in a case where a subcarrier spacing of a physical downlink control channel is different.

Illustratively, the minimum feedback delay between the last symbol of the DCI for SPS deactivation and the ACK feedback is defined as N=20 in a case where the subcarrier spacing of the physical downlink control channel is 15 kHz. That is, the acknowledge feedback is sent after 20 symbol intervals from receiving the last symbol of the DCI. The minimum feedback delay between the last symbol of the DCI for SPS deactivation and the ACK feedback is defined as N=44 in a case where the subcarrier spacing of the physical downlink control channel is 30 kHz. That is, the acknowledge feedback is sent after 44 symbol intervals from receiving the last symbol of the DCI.

In an example, the terminal includes a first type of terminal and a second type of terminal. The first type of terminal is at least one of an enhanced reduced capability terminal or a terminal having a relaxed processing capability, and the second type of terminal has no relaxed processing capability; and the minimum feedback delay corresponding to the first type of terminal is greater than the minimum feedback delay corresponding to the second type of terminal in a case where the subcarrier spacing of the physical downlink control channel is the same.

The terminal having a relaxed processing capability may refer to relaxing a PDSCH/PUSCH processing delay of the terminal. For example, the PDSCH processing delay of the terminal is relaxed to twice an original value. Because the value of the PDSCH processing delay is partially derived from a blind detection delay of a PDCCH, the blind detection delay of the PDCCH is also relaxed while the PDSCH processing delay is relaxed.

Understandably, the terminal having a relaxed processing capability may be an enhanced reduced capability terminal that introduces a relaxed processing capability, or may be a common terminal having a relaxed processing capability. The first type of terminal may include all enhanced reduced capability terminals, or may include enhanced reduced capability terminals having relaxed processing capabilities, or may include all enhanced reduced capability terminals and common terminals having relaxed processing capabilities.

In an example, the minimum feedback delay corresponding to the first type of terminal is twice the minimum feedback delay corresponding to the second type of terminal in a case where the subcarrier spacing of the physical downlink control channel is the same.

Illustratively, if the subcarrier spacing of the physical downlink control channel is 15 kHz, and the minimum feedback delay corresponding to the second type of terminal is N=10, the minimum feedback delay corresponding to the first type of terminal may be N=20. That is, the acknowledge feedback is sent after 20 symbol intervals from receiving the last symbol of the DCI. If the subcarrier spacing of the physical downlink control channel is 30 kHz, and the minimum feedback delay corresponding to the second type of terminal is N=22, the minimum feedback delay corresponding to the first type of terminal may be N=44. That is, the acknowledge feedback is sent after 44 symbol intervals from receiving the last symbol of the DCI.

It is worth noting that the second type of terminal may support two different PDSCH channel processing capabilities, and for example, may support a capability 1 and a capability 2. The capability 2 is provided for a service such as URLLC and may support a faster processing delay. N=10 corresponds to a processing delay of the capability 1, and a processing delay of the capability 2 is less than that of the capability 1. The terminal having a relaxed processing capability (for example, an enhanced reduced capability (eRedCap) terminal having a relaxed processing capability) described above may be further relaxed based on the capability 1.

In the embodiment of the present disclosure, the minimum feedback delays for the semi-persistent scheduling deactivation of the terminals having different processing capabilities are distinguished such that the terminals having different processing capabilities can send the acknowledge feedback after a number of symbol intervals corresponding to the minimum feedback delays of the terminals in response to receiving the last symbol of the downlink control information for the semi-persistent scheduling deactivation sent by the base station, thus effectively preventing the base station from unreasonably indicating the feedback time, and ensuring that the terminals have sufficient time to decode the PDCCH and prepare the ACK feedback. Thus, the acknowledge feedback for SPS release can be successfully sent.

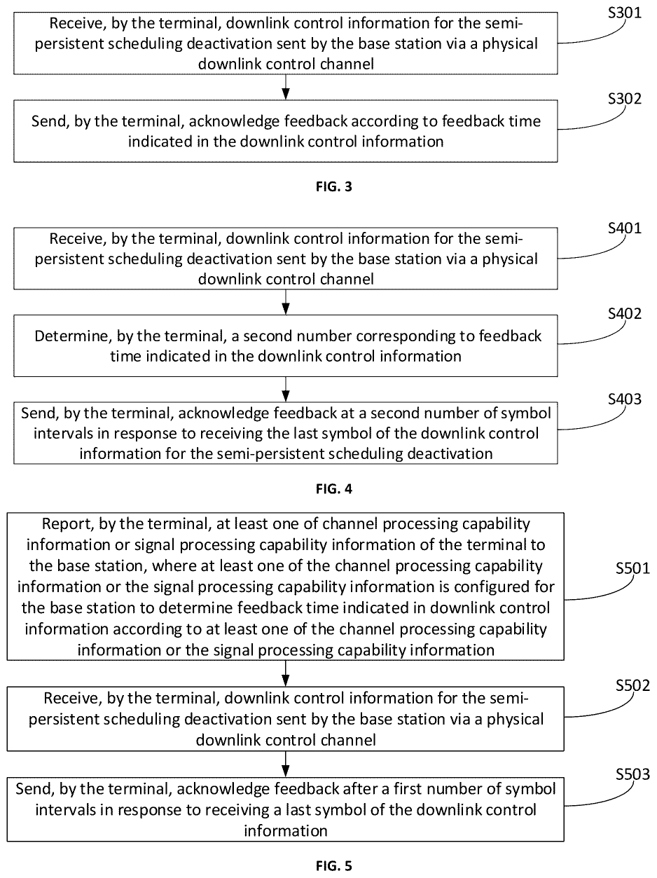

FIG. 3 is a flowchart of a feedback method for semi-persistent scheduling deactivation shown according to an example. The method is performed by a terminal. As shown in FIG. 3, the method includes the following steps S301-S302.

S301, downlink control information for the semi-persistent scheduling deactivation sent by a base station via a physical downlink control channel is received by the terminal.

S302, acknowledge feedback is sent by the terminal according to feedback time indicated in the downlink control information.

The feedback time is greater than the minimum feedback delay corresponding to the terminal. That is, a symbol number corresponding to the feedback time is greater than or equal to the first number. In some examples, the feedback time may be determined by a base station based on the minimum feedback delay and a certain scheduling policy.

The first number of symbol intervals is a number of symbols corresponding to a minimum feedback delay of the terminal, and in a case where a subcarrier spacing of the physical downlink control channel is the same, different minimum feedback delays correspond to terminals having at least one of different channel processing capabilities or different signal processing capabilities.

The acknowledge feedback may be acknowledge character (ACK) feedback. Specifically, acknowledge information may be carried via hybrid automatic repeat request-acknowledgement (HARQ-ACK). The acknowledge feedback may be used to feed back to the base station whether deactivation succeeds.

In some possible implementations, the minimum feedback delay is predefined based on a communication protocol and a terminal processing capability, and it is predetermined in the communication protocol that different minimum feedback delays correspond to terminals having at least one of different channel processing capabilities or different signal processing capabilities in a case where a subcarrier spacing of a physical downlink control channel is the same. In some examples, in a case where the subcarrier spacing of the physical downlink control channel is the same, the same minimum feedback delays may correspond to the terminals having at least one of the same channel processing capability or the same signal processing capability.

In some possible implementations, different minimum feedback delays may correspond to terminals having the same signal processing capability in a case where a subcarrier spacing of a physical downlink control channel is different.

Illustratively, the minimum feedback delay between the last symbol of the DCI for SPS deactivation and the ACK feedback is defined as N=20 in a case where the subcarrier spacing of the physical downlink control channel is 15 kHz. That is, the acknowledge feedback is sent after 20 symbol intervals from receiving the last symbol of the DCI. The minimum feedback delay between the last symbol of the DCI for SPS deactivation and the ACK feedback is defined as N=44 in a case where the subcarrier spacing of the physical downlink control channel is 30 kHz. That is, the acknowledge feedback is sent after 44 symbol intervals from receiving the last symbol of the DCI.

In an example, the terminal includes a first type of terminal and a second type of terminal. The first type of terminal is at least one of an enhanced reduced capability terminal or a terminal having a relaxed processing capability, and the second type of terminal has no relaxed processing capability; and the minimum feedback delay corresponding to the first type of terminal is greater than the minimum feedback delay corresponding to the second type of terminal in a case where the subcarrier spacing of the physical downlink control channel is the same.

The terminal having a relaxed processing capability may refer to relaxing a PDSCH/PUSCH processing delay of the terminal. For example, the PDSCH processing delay of the terminal is relaxed to twice an original value. Because the value of the PDSCH processing delay is partially derived from a blind detection delay of a PDCCH, the blind detection delay of the PDCCH is also relaxed while the PDSCH processing delay is relaxed.

In an example, the minimum feedback delay corresponding to the first type of terminal is twice the minimum feedback delay corresponding to the second type of terminal in a case where the subcarrier spacing of the physical downlink control channel is the same.

Illustratively, if the subcarrier spacing of the physical downlink control channel is 15 kHz, and a minimum feedback delay corresponding to the second type of terminal is N=10, the minimum feedback delay corresponding to the first type of terminal may be N=20. That is, the acknowledge feedback is sent after 20 symbol intervals from receiving the last symbol of the DCI. If the subcarrier spacing of the physical downlink control channel is 30 kHz, and the minimum feedback delay corresponding to the second type of terminal is N=22, the minimum feedback delay corresponding to the first type of terminal may be N=44. That is, the acknowledge feedback is sent after 44 symbol intervals from receiving the last symbol of the DCI.

In the embodiment of the present disclosure, the minimum feedback delays of the semi-persistent scheduling deactivation of the terminals having different processing capabilities are distinguished such that the base station can indicate the feedback time based on the minimum feedback delays of different terminals. Thus, the terminals send the acknowledge feedback according to the feedback time indicated by the base station in a case where the last symbol of the downlink control information for the semi-persistent scheduling deactivation sent by the base station is received, thus effectively preventing the base station from unreasonably indicating the feedback time, and ensuring that the terminals have sufficient time to decode the PDCCH and prepare the ACK feedback. Thus, the acknowledge feedback for SPS release can be successfully sent.

FIG. 4 is a flowchart of a feedback method for the semi-persistent scheduling deactivation shown according to an example. The method is performed by a terminal. As shown in FIG. 4, the method includes the following steps S401-S403.

S401, downlink control information for the semi-persistent scheduling deactivation sent by a base station via a physical downlink control channel is received by the terminal.

S402, a second number corresponding to feedback time indicated in the downlink control information is determined by the terminal.

The feedback time is greater than a minimum feedback delay corresponding to the terminal. Understandably, the second number is greater than a first number corresponding to the minimum feedback delay of the terminal. In some examples, the feedback time may be determined by a base station based on the minimum feedback delay and a certain scheduling policy.

S403, acknowledge feedback is sent by the terminal at a second number of symbol intervals in response to receiving the last symbol of the downlink control information for the semi-persistent scheduling deactivation.

The first number of symbol intervals is a number of symbols corresponding to a minimum feedback delay of the terminal, and in a case where a subcarrier spacing of the physical downlink control channel is the same, different minimum feedback delays correspond to terminals having at least one of different channel processing capabilities or different signal processing capabilities.

Specifically, in a case of sending the acknowledge feedback at the second number of symbol intervals, the acknowledge feedback may start to be sent at a first symbol after the second number of symbol intervals.

The acknowledge feedback may be acknowledge character (ACK) feedback. Specifically, acknowledge information may be carried via hybrid automatic repeat request-acknowledgement (HARQ-ACK).

In some possible implementations, the minimum feedback delay is predefined based on a communication protocol and a terminal processing capability, and it is predetermined in the communication protocol that different minimum feedback delays correspond to terminals having at least one of different channel processing capabilities or different signal processing capabilities in a case where a subcarrier spacing of a physical downlink control channel is the same. In some examples, in a case where the subcarrier spacing of the physical downlink control channel is the same, the same minimum feedback delays may correspond to the terminals having at least one of the same channel processing capability or the same signal processing capability.

In some possible implementations, different minimum feedback delays may correspond to terminals having the same signal processing capability in a case where a subcarrier spacing of a physical downlink control channel is different.

Illustratively, the minimum feedback delay between the last symbol of the DCI for SPS deactivation and the ACK feedback is defined as N=20 in a case where the subcarrier spacing of the physical downlink control channel is 15 kHz. That is, the acknowledge feedback is sent after 20 symbol intervals from receiving the last symbol of the DCI. The minimum feedback delay between the last symbol of the DCI for SPS deactivation and the ACK feedback is defined as N=44 in a case where the subcarrier spacing of the physical downlink control channel is 30 kHz. That is, the acknowledge feedback is sent after 44 symbol intervals from receiving the last symbol of the DCI.

In an example, the terminal includes a first type of terminal and a second type of terminal. The first type of terminal is at least one of an enhanced reduced capability terminal or a terminal having a relaxed processing capability, and the second type of terminal has no relaxed processing capability; and the minimum feedback delay corresponding to the first type of terminal is greater than the minimum feedback delay corresponding to the second type of terminal in a case where the subcarrier spacing of the physical downlink control channel is the same.

The terminal having a relaxed processing capability may refer to relaxing a PDSCH/PUSCH processing delay of the terminal. For example, the PDSCH processing delay of the terminal is relaxed to twice an original value. Because the value of the PDSCH processing delay is partially derived from a blind detection delay of a PDCCH, the blind detection delay of the PDCCH is also relaxed while the PDSCH processing delay is relaxed.

In an example, the minimum feedback delay corresponding to the first type of terminal is twice the minimum feedback delay corresponding to the second type of terminal in a case where the subcarrier spacing of the physical downlink control channel is the same.

Illustratively, if the subcarrier spacing of the physical downlink control channel is 15 kHz, and the minimum feedback delay corresponding to the second type of terminal is N=10, the minimum feedback delay corresponding to the first type of terminal may be N=20. That is, the acknowledge feedback is sent after 20 symbol intervals from receiving the last symbol of the DCI. If the subcarrier spacing of the physical downlink control channel is 30 kHz, and the minimum feedback delay corresponding to the second type of terminal is N=22, the minimum feedback delay corresponding to the first type of terminal may be N=44. That is, the acknowledge feedback is sent after 44 symbol intervals from receiving the last symbol of the DCI.

In the embodiment of the present disclosure, the minimum feedback delays of the semi-persistent scheduling deactivation of the terminals having different processing capabilities are distinguished such that the base station can indicate the feedback time based on the minimum feedback delays of different terminals. Thus, the terminal determine a second number corresponding to the feedback time according to the feedback time indicated by the base station in response to receiving the last symbol of the downlink control information for the semi-persistent scheduling deactivation sent by the base station, and send the acknowledge feedback at a target moment, thus effectively preventing the base station from unreasonably indicating the feedback time, and ensuring that the terminals have sufficient time to decode the PDCCH and prepare the ACK feedback. Thus, the acknowledge feedback for SPS release can be successfully sent.

FIG. 5 is a flowchart of a feedback method for the semi-persistent scheduling deactivation shown according to an example. The method is performed by a terminal. As shown in FIG. 5, the method includes the following steps S501-S503.

S501, at least one of channel processing capability information or signal processing capability information of the terminal is reported by the terminal to a base station, where at least one of the channel processing capability information or the signal processing capability information is configured for the base station to determine feedback time indicated in downlink control information according to at least one of the channel processing capability information or the signal processing capability information.

S502, downlink control information for the semi-persistent scheduling deactivation sent by a base station via a physical downlink control channel is received by the terminal.

S503, acknowledge feedback is sent by the terminal after a first number of symbol intervals in response to receiving a last symbol of the downlink control information.

The first number of symbol intervals is a number of symbols corresponding to a minimum feedback delay of the terminal, and in a case where a subcarrier spacing of the physical downlink control channel is the same, different minimum feedback delays correspond to terminals having at least one of different channel processing capabilities or different signal processing capabilities.

Understandably, after the terminal reports at least one of the channel processing capability information or the signal processing capability information of the terminal to the base station, the base station may determine the minimum feedback delay of the terminal based on at least one of the channel processing capability information or the signal processing capability information of the terminal (correspondingly, may further determine the first number corresponding to the minimum feedback delay of the terminal), and determine the feedback time based on the minimum feedback delay of the terminal, such that the feedback time is greater than or equal to the minimum feedback delay of the terminal (correspondingly, the second number corresponding to the feedback delay is greater than or equal to the first number). Thus, the terminal can send the acknowledge feedback after the minimum feedback delay corresponding to the terminal, thus avoiding failure of the terminal to send feedback caused by unreasonable indication of the feedback time by the base station.

In some examples, downlink control information may include feedback time. In S503, the terminal may determine a second number corresponding to the feedback time indicated in the downlink control information. Moreover, acknowledge feedback is sent at a second number of symbol intervals corresponding to the feedback time in response to receiving the last symbol of the downlink control information for the semi-persistent scheduling deactivation. The second number is greater than or equal to the first number.

The acknowledge feedback may be acknowledge character (ACK) feedback. Specifically, acknowledge information may be carried via hybrid automatic repeat request-acknowledgement (HARQ-ACK).

In some possible implementations, the minimum feedback delay is predefined based on a communication protocol and a terminal processing capability, and it is predetermined in the communication protocol that different minimum feedback delays correspond to terminals having at least one of different channel processing capabilities or different signal processing capabilities in a case where a subcarrier spacing of a physical downlink control channel is the same. In some examples, in a case where the subcarrier spacing of the physical downlink control channel is the same, the same minimum feedback delays may correspond to the terminals having at least one of the same channel processing capability or the same signal processing capability.

In some possible implementations, different minimum feedback delays may correspond to terminals having the same signal processing capability in a case where a subcarrier spacing of a physical downlink control channel is different.

Illustratively, the minimum feedback delay between the last symbol of the DCI for SPS deactivation and the ACK feedback is defined as N=20 in a case where the subcarrier spacing of the physical downlink control channel is 15 kHz. That is, the acknowledge feedback is sent after 20 symbol intervals from receiving the last symbol of the DCI. The minimum feedback delay between the last symbol of the DCI for SPS deactivation and the ACK feedback is defined as N=44 in a case where the subcarrier spacing of the physical downlink control channel is 30 kHz. That is, the acknowledge feedback is sent after 44 symbol intervals from receiving the last symbol of the DCI.

In an example, the terminal includes a first type of terminal and a second type of terminal. The first type of terminal is at least one of an enhanced reduced capability terminal or a terminal having a relaxed processing capability, and the second type of terminal has no relaxed processing capability; and the minimum feedback delay corresponding to the first type of terminal is greater than the minimum feedback delay corresponding to the second type of terminal in a case where the subcarrier spacing of the physical downlink control channel is the same.

The terminal having a relaxed processing capability may refer to relaxing a PDSCH/PUSCH processing delay of the terminal. For example, the PDSCH processing delay of the terminal is relaxed to twice an original value. Because the value of the PDSCH processing delay is partially derived from a blind detection delay of a PDCCH, the blind detection delay of the PDCCH is also relaxed while the PDSCH processing delay is relaxed.

In an example, the minimum feedback delay corresponding to the first type of terminal is twice the minimum feedback delay corresponding to the second type of terminal in a case where the subcarrier spacing of the physical downlink control channel is the same.

Illustratively, if the subcarrier spacing of the physical downlink control channel is 15 kHz, and the minimum feedback delay corresponding to the second type of terminal is N=10, the minimum feedback delay corresponding to the first type of terminal may be N=20. That is, the acknowledge feedback is sent after 20 symbol intervals from receiving the last symbol of the DCI. If the subcarrier spacing of the physical downlink control channel is 30 kHz, and the minimum feedback delay corresponding to the second type of terminal is N=22, the minimum feedback delay corresponding to the first type of terminal may be N=44. That is, the acknowledge feedback is sent after 44 symbol intervals from receiving the last symbol of the DCI.

In some possible implementations, at least one of channel processing capability information or signal processing capability information of the terminal may be sent via a random access signaling, or may be sent in other ways, which is not limited in the present disclosure.

Specifically, the base station determines the feedback time indicated in the downlink control information according to at least one of the channel processing capability information or the signal processing capability information, it may be, the base station determines a type of the terminal according to at least one of the channel processing capability information or signal processing capability information. Illustratively, if the base station determines that the terminal is the first type of terminal based on at least one of the channel processing capability or signal processing capability, and the subcarrier spacing of the physical downlink control channel is 15 kHz, the symbol intervals corresponding to the feedback time may be set to be greater than 20. If the base station determines that the terminal is the second type of terminal based on at least one of the channel processing capability or signal processing capability, and the subcarrier spacing of the physical downlink control channel is 15 kHz, the symbol intervals corresponding to the feedback time may be set to be greater than 10.

In the embodiment of the present disclosure, the minimum feedback delays of the semi-persistent scheduling deactivation of the terminals having different processing capabilities are distinguished, and at least one of the channel processing capability information or the signal processing capability information of the terminals are reported via the terminals such that the base station can determine the feedback time and indicate the terminals based on at least one of channel processing capabilities or signal processing capabilities of the terminals. Thus, the terminals send the acknowledge feedback after the minimum feedback delays in response to receiving the last symbol of the downlink control information for the semi-persistent scheduling deactivation sent by the base station, thus effectively preventing the base station from unreasonably indicating the feedback time, and ensuring that the terminals have sufficient time to decode the PDCCH and prepare the ACK feedback. Thus, the acknowledge feedback for SPS release can be successfully sent.

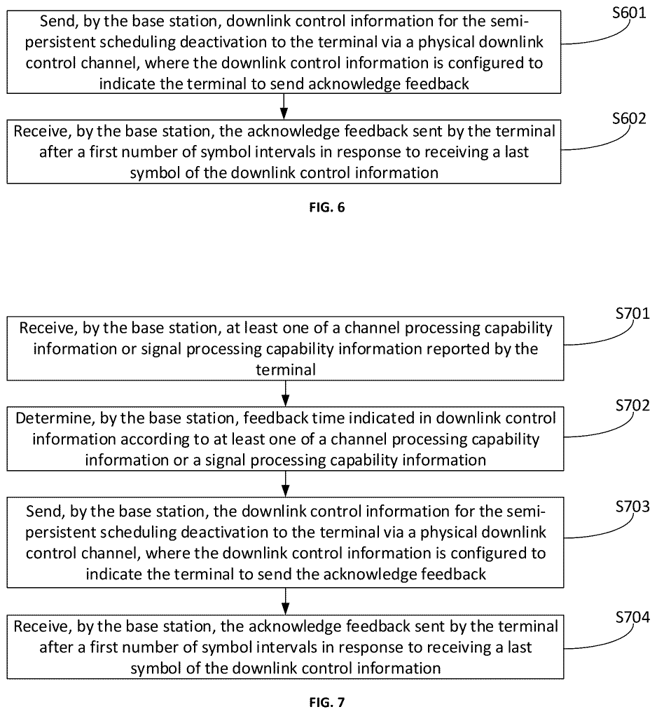

FIG. 6 is a flowchart of a feedback method for the semi-persistent scheduling deactivation shown according to an example. The method is performed by a base station. As shown in FIG. 6, the method includes the following steps S601-S602.

S601, downlink control information for the semi-persistent scheduling deactivation is sent by the base station to a terminal via a physical downlink control channel, where the downlink control information is configured to indicate the terminal to send acknowledge feedback.

S602, the acknowledge feedback sent by the terminal is received by the base station after a first number of symbol intervals in response to receiving a last symbol of the downlink control information.

It is worth noting that the downlink control information may be configured to indicate the terminal to send the acknowledge feedback, and may be further configured to indicate the terminal to perform other actions, which is not specifically limited in the present disclosure. Further, the downlink control information may be specifically configured to indicate the terminal to deactivate semi-persistent scheduling, and send the acknowledge feedback according to a deactivation condition of the semi-persistent scheduling. That is, the acknowledge feedback sent by the terminal may be an execution result sent by the terminal after execution according to an indication in the downlink control information. For example, the acknowledge feedback may be configured to inform the base station that the terminal has successfully deactivated the semi-persistent scheduling.

The first number of symbol intervals is a number of symbols corresponding to a minimum feedback delay of the terminal, and in a case where a subcarrier spacing of the physical downlink control channel is the same, different minimum feedback delays correspond to terminals having at least one of different channel processing capabilities or different signal processing capabilities.

The base station may receive acknowledge character (ACK) feedback sent via the terminal to receive the acknowledge feedback. Specifically, acknowledge information may be carried via hybrid automatic repeat request-acknowledgement (HARQ-ACK).

In some possible implementations, the minimum feedback delay is predefined based on a communication protocol and a terminal processing capability, and it is predetermined in the communication protocol that different minimum feedback delays correspond to terminals having different signal processing capabilities in a case where a subcarrier spacing of a physical downlink control channel is the same. In some examples, the same minimum feedback delays may correspond to the terminals having the same signal processing capability in a case where the subcarrier spacing of the physical downlink control channel is the same.

Illustratively, the minimum feedback delay between the last symbol of the DCI for SPS deactivation and the ACK feedback is defined as N=20 in a case where the subcarrier spacing of the physical downlink control channel is 15 kHz. That is, the terminal sends the acknowledge feedback after 20 symbol intervals from receiving the last symbol of the DCI. The minimum feedback delay between the last symbol of the DCI for SPS deactivation and the ACK feedback is defined as N=44 in a case where the subcarrier spacing of the physical downlink control channel is 30 kHz. That is, the terminal sends the acknowledge feedback after 44 symbol intervals from receiving the last symbol of the DCI.

In an example, the downlink control information is configured to indicate the terminal to send the acknowledge feedback according to feedback time indicated in the downlink control information. The feedback time is greater than the minimum feedback delay corresponding to the terminal.

That is, a symbol number corresponding to the feedback time is greater than or equal to a first number. In some implementations, the feedback time may be determined by a base station based on the minimum feedback delay and a certain scheduling policy.

In another example, the feedback time is configured for the terminal to determine a second number corresponding to the feedback time, and the second number is configured for the terminal to send acknowledge feedback at a second number of symbol intervals in response to receiving the last symbol of the downlink control information for the semi-persistent scheduling deactivation.

Specifically, in a case that the terminal sends the acknowledge feedback at a second number of symbol intervals, it may be, the terminal may start sending the acknowledge feedback at a first symbol after a second number of symbol intervals.

In an example, the terminal includes a first type of terminal and a second type of terminal. The first type of terminal is at least one of an enhanced reduced capability terminal or a terminal having a relaxed processing capability, and the second type of terminal has no relaxed processing capability; and the minimum feedback delay corresponding to the first type of terminal is greater than the minimum feedback delay corresponding to the second type of terminal in a case where the subcarrier spacing of the physical downlink control channel is the same.

The terminal having a relaxed processing capability may refer to relaxing a PDSCH/PUSCH processing delay of the terminal. For example, the PDSCH processing delay of the terminal is relaxed to twice an original value. Because the value of the PDSCH processing delay is partially derived from a blind detection delay of a PDCCH, the blind detection delay of the PDCCH is also relaxed while the PDSCH processing delay is relaxed.

In an example, the minimum feedback delay corresponding to the first type of terminal is twice the minimum feedback delay corresponding to the second type of terminal in a case where the subcarrier spacing of the physical downlink control channel is the same.

Illustratively, if the subcarrier spacing of the physical downlink control channel is 15 kHz, and the minimum feedback delay corresponding to the second type of terminal is N=10, the minimum feedback delay corresponding to the first type of terminal may be N=20. That is, the acknowledge feedback is sent after 20 symbol intervals from receiving the last symbol of the DCI. If the subcarrier spacing of the physical downlink control channel is 30 kHz, and the minimum feedback delay corresponding to the second type of terminal is N=22, the minimum feedback delay corresponding to the first type of terminal may be N=44. That is, the acknowledge feedback is sent after 44 symbol intervals from receiving the last symbol of the DCI.

In the embodiment of the present disclosure, the minimum feedback delays of the semi-persistent scheduling deactivation of the terminals having different processing capabilities are distinguished such that the terminals having different processing capabilities can send the acknowledge feedback after a number of symbol intervals corresponding to the minimum feedback delays of the terminals in response to receiving the last symbol of the downlink control information for the semi-persistent scheduling deactivation sent by the base station, thus effectively preventing the base station from unreasonably indicating the feedback time, and ensuring that the terminals have sufficient time to decode the PDCCH and prepare the ACK feedback. Thus, the acknowledge feedback for SPS release can be successfully sent.

FIG. 7 is a flowchart of a feedback method for semi-persistent scheduling deactivation shown according to an example. The method is performed by a base station. As shown in FIG. 7, the method includes the following steps S701-S704.

S701, at least one of a channel processing capability information or signal processing capability information reported by the terminal is received by the base station.

S702, feedback time indicated in downlink control information is determined by the base station according to at least one of a channel processing capability information or a signal processing capability information.

S703, the downlink control information for the semi-persistent scheduling deactivation is sent by the base station to the terminal via a physical downlink control channel, where the downlink control information is configured to indicate the terminal to send acknowledge feedback.

S704, the acknowledge feedback sent by the terminal is received by the base station after a first number of symbol intervals in response to receiving a last symbol of the downlink control information.

The first number of symbol intervals is a number of symbols corresponding to a minimum feedback delay of the terminal, and in a case where a subcarrier spacing of the physical downlink control channel is the same, different minimum feedback delays correspond to terminals having at least one of different channel processing capabilities or different signal processing capabilities.

Understandably, in some examples, downlink control information may include feedback time. A terminal may determine a second number corresponding to feedback time indicated in the downlink control information, and send acknowledge feedback at a second number of symbol intervals corresponding to the feedback time in response to receiving the last symbol of the downlink control information for the semi-persistent scheduling deactivation. The second number corresponds to the feedback time. The second number may be greater than or equal to the first number. That is, in S704, the base station may receive acknowledge feedback sent by the terminal at a second number of symbol intervals in response to receiving the last symbol of the downlink control information for the semi-persistent scheduling deactivation.

The base station may receive acknowledge character (ACK) feedback sent via the terminal to receive the acknowledge feedback. Specifically, acknowledge information may be carried via hybrid automatic repeat request-acknowledgement (HARQ-ACK).

In some possible implementations, the minimum feedback delay is predefined based on a communication protocol and a terminal processing capability, and it is predetermined in the communication protocol that different minimum feedback delays correspond to terminals having different signal processing capabilities in a case where a subcarrier spacing of a physical downlink control channel is the same. In some examples, the same minimum feedback delays may correspond to the terminals having the same signal processing capability in a case where the subcarrier spacing of the physical downlink control channel is the same.

Illustratively, the minimum feedback delay between the last symbol of the DCI for SPS deactivation and the ACK feedback is defined as N=20 in a case where the subcarrier spacing of the physical downlink control channel is 15 kHz. That is, the terminal sends the acknowledge feedback after 20 symbol intervals from receiving the last symbol of the DCI. The minimum feedback delay between the last symbol of the DCI for SPS deactivation and the ACK feedback is defined as N=44 in a case where the subcarrier spacing of the physical downlink control channel is 30 kHz. That is, the terminal sends the acknowledge feedback after 44 symbol intervals from receiving the last symbol of the DCI.

In an example, the downlink control information is configured to indicate the terminal to send the acknowledge feedback according to feedback time indicated in the downlink control information. The feedback time is greater than the minimum feedback delay corresponding to the terminal.

That is, a symbol number corresponding to the feedback time is greater than or equal to the first number. In some implementations, the feedback time may be determined by a base station based on the minimum feedback delay and a certain scheduling policy.

In another example, the feedback time is configured for the terminal to determine a second number corresponding to the feedback time, and the second number is configured for the terminal to send acknowledge feedback at a second number of symbol intervals in response to receiving the last symbol of the downlink control information for the semi-persistent scheduling deactivation.

Specifically, in a case that the terminal sends the acknowledge feedback at a second number of symbol intervals, it may be, the terminal may start sending the acknowledge feedback at a first symbol after a second number of symbol intervals.

In an example, the terminal includes a first type of terminal and a second type of terminal. The first type of terminal is at least one of an enhanced reduced capability terminal or a terminal having a relaxed processing capability, and the second type of terminal has no relaxed processing capability; and the minimum feedback delay corresponding to the first type of terminal is greater than the minimum feedback delay corresponding to the second type of terminal in a case where the subcarrier spacing of the physical downlink control channel is the same.

The terminal having a relaxed processing capability may refer to relaxing a PDSCH/PUSCH processing delay of the terminal. For example, the PDSCH processing delay of the terminal is relaxed to twice an original value. Because the value of the PDSCH processing delay is partially derived from a blind detection delay of a PDCCH, the blind detection delay of the PDCCH is also relaxed while the PDSCH processing delay is relaxed.

In an example, the minimum feedback delay corresponding to the first type of terminal is twice the minimum feedback delay corresponding to the second type of terminal in a case where the subcarrier spacing of the physical downlink control channel is the same.

Illustratively, if the subcarrier spacing of the physical downlink control channel is 15 kHz, and the minimum feedback delay corresponding to the second type of terminal is N=10, the minimum feedback delay corresponding to the first type of terminal may be N=20. That is, the acknowledge feedback is sent after 20 symbol intervals from receiving the last symbol of the DCI. If the subcarrier spacing of the physical downlink control channel is 30 kHz, and the minimum feedback delay corresponding to the second type of terminal is N=22, the minimum feedback delay corresponding to the first type of terminal may be N=44. That is, the acknowledge feedback is sent after 44 symbol intervals from receiving the last symbol of the DCI.

In some possible implementations, at least one of channel processing capability information or signal processing capability information of the terminal may be sent via a random access signaling, or may be sent in other ways, which is not limited in the present disclosure.

Specifically, the base station determines the feedback time indicated in the downlink control information according to at least one of the channel processing capability information or the signal processing capability information, it may be, the base station determines a type of the terminal according to at least one of the channel processing capability information or signal processing capability information. Illustratively, if the base station determines that the terminal is the first type of terminal based on at least one of the channel processing capability information or signal processing capability information, and the subcarrier spacing of the physical downlink control channel is 15 kHz, it may be determined that the minimum feedback delay of the terminal is N=20, and the symbol intervals corresponding to the feedback time are set to be greater than 20. If the base station determines that the terminal is the second type of terminal based on at least one of the channel processing capability information or signal processing capability information, and the subcarrier intervals of the physical downlink control channel are 15 kHz, it may be determined that the minimum feedback delay of the terminal is N=10, and the symbol intervals corresponding to the feedback time are set to be greater than 10.

In the embodiment of the present disclosure, the minimum feedback delays of the semi-persistent scheduling deactivation of the terminals having different processing capabilities are distinguished, and at least one of the channel processing capability information or the signal processing capability information of the terminals are reported via the terminals such that the base station can determine the feedback time and indicate the terminals based on at least one of channel processing capabilities or signal processing capabilities of the terminals. Thus, the terminals send the acknowledge feedback after the minimum feedback delays in response to receiving the last symbol of the downlink control information for the semi-persistent scheduling deactivation sent by the base station, thus effectively preventing the base station from unreasonably indicating the feedback time, and ensuring that the terminals have sufficient time to decode the PDCCH and prepare the ACK feedback. Thus, the acknowledge feedback for SPS release can be successfully sent.

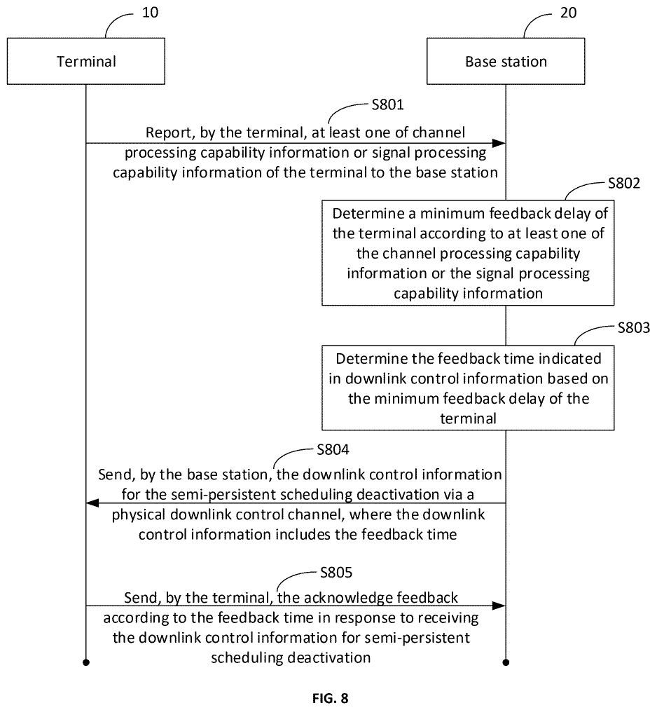

In order to enable those skilled in the art to better understand the technical solution according to the present disclosure, the present disclosure further provides an interaction diagram of a feedback method for semi-persistent scheduling deactivation shown according to an example as shown in FIG. 8. As shown in FIG. 8, the method includes following steps S801-S801.

S801, at least one of channel processing capability information or signal processing capability information of the terminal is reported by the terminal 10 to a base station 20.

The terminal may be a first type of terminal or a second type of terminal. The first type of terminal is at least one of an enhanced reduced capability terminal or a terminal having a relaxed processing capability, and the second type of terminal has no relaxed processing capability; and the minimum feedback delay corresponding to the first type of terminal is greater than the minimum feedback delay corresponding to the second type of terminal in a case where a subcarrier spacing of a physical downlink control channel is the same.

In some examples, at least one of the channel processing capability information or the signal processing capability information may be sent when the terminal accesses the base station.

S802, the minimum feedback delay of the terminal 10 is determined by the base station 20 according to at least one of the channel processing capability information or the signal processing capability information.

The base station may determine a type of the terminal based on at least one of the channel processing capability information or the signal processing capability information, and may further query a predefined communication protocol according to the type of the terminal, so as to determine the minimum feedback delay of the terminal of the type.

It is worth noting that different minimum feedback delays correspond to different types of terminals (i.e. terminals having at least one of different channel processing capabilities or different signal processing capabilities) in a case where the subcarrier spacing of the physical downlink control channel is the same.

S803, feedback time indicated in downlink control information is determined by the base station 20 based on the minimum feedback delay of the terminal 10.

The feedback time is greater than or equal to the minimum feedback delay. That is, the second number corresponding to the feedback time is greater than or equal to the first number corresponding to the minimum feedback delay.

S804, the downlink control information for the semi-persistent scheduling deactivation is sent by the base station 20 via a physical downlink control channel, where the downlink control information includes feedback time.

S805, acknowledge feedback is sent by the terminal 10 according to the feedback time in response to receiving the downlink control information for the semi-persistent scheduling deactivation.

The feedback time is greater than the minimum feedback delay of the terminal. Specifically, sending the acknowledge feedback according to the feedback time, it may be, the acknowledge feedback may be sent at the second number of symbol intervals corresponding to the feedback time after the last symbol of the downlink control information for the semi-persistent scheduling deactivation is received.

In the embodiment of the present disclosure, the minimum feedback delays of the semi-persistent scheduling deactivation of the terminals having different processing capabilities are distinguished, and at least one of the channel processing capability information or the signal processing capability information of the terminals are reported via the terminals such that the base station can determine the feedback time and indicate the terminals based on at least one of channel processing capabilities or signal processing capabilities of the terminals. Thus, the terminals can send the acknowledge feedback after the minimum feedback delays in response to receiving the last symbol of the downlink control information for the semi-persistent scheduling deactivation sent by the base station, thus effectively preventing the base station from unreasonably indicating the feedback time, and ensuring that the terminals have sufficient time to decode the PDCCH and prepare the ACK feedback. Thus, the acknowledge feedback for SPS release can be successfully sent.

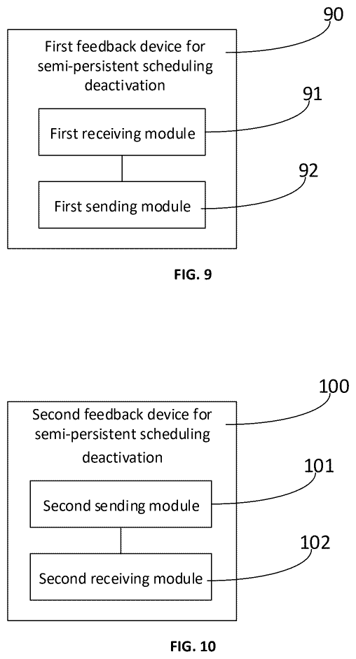

FIG. 9 is a block diagram of a feedback device for semi-persistent scheduling deactivation shown according to an example. The device is applied to a terminal. As shown in FIG. 9, a first feedback device 90 for semi-persistent scheduling deactivation includes a first receiving module 91 and a first sending module 92.

The first receiving module 91 is configured to receive downlink control information for the semi-persistent scheduling deactivation sent by a base station via a physical downlink control channel.

The first sending module 92 is configured to send acknowledge feedback after a first number of symbol intervals in response to receiving a last symbol of the downlink control information.

The first number of symbol intervals is a number of symbols corresponding to a minimum feedback delay of the terminal, and in a case where a subcarrier spacing of the physical downlink control channel is the same, different minimum feedback delays correspond to terminals having at least one of different channel processing capabilities or different signal processing capabilities.

In some examples, the first sending module 92 is configured to send the acknowledge feedback according to feedback time indicated in the downlink control information.

The feedback time is greater than the minimum feedback delay corresponding to the terminal.

In some examples, the terminal includes a first type of terminal and a second type of terminal. The first type of terminal is at least one of an enhanced reduced capability terminal or a terminal having a relaxed processing capability, and the second type of terminal has no relaxed processing capability; and the minimum feedback delay corresponding to the first type of terminal is greater than the minimum feedback delay corresponding to the second type of terminal in a case where the subcarrier spacing of the physical downlink control channel is the same.

In some examples, the minimum feedback delay corresponding to the first type of terminal is twice the minimum feedback delay corresponding to the second type of terminal in a case where the subcarrier spacing of the physical downlink control channel is the same.

In some examples, the first sending module 92 is configured to: determine a second number corresponding to the feedback time; and send the acknowledge feedback at a second number of symbol intervals in response to receiving the last symbol of the downlink control information for the semi-persistent scheduling deactivation.

In some examples, the first feedback device 90 for semi-persistent scheduling deactivation includes: a reporting module (not shown), configured to report at least one of channel processing capability information or signal processing capability information of the terminal to the base station. At least one of the channel processing capability information or the signal processing capability information is configured for the base station to determine the feedback time indicated in the downlink control information according to at least one of the channel processing capability information or the signal processing capability information.

FIG. 10 is a block diagram of a feedback device for semi-persistent scheduling deactivation shown according to an example. The device is applied to a base station. As shown in FIG. 10, a second feedback device 100 for semi-persistent scheduling deactivation includes a second sending module 101 and a second receiving module 102.

The second sending module 101 is configured to send downlink control information for the semi-persistent scheduling deactivation to a terminal via a physical downlink control channel, where the downlink control information is configured to indicate the terminal to send acknowledge feedback.

The second receiving module 102 is configured to receive the acknowledge feedback sent by the terminal. The terminal sends the acknowledge feedback after a first number of symbol intervals in response to receiving a last symbol of the downlink control information.

The first number of symbol intervals is a number of symbols corresponding to a minimum feedback delay of the terminal, and in a case where a subcarrier spacing of the physical downlink control channel is the same, different minimum feedback delays correspond to terminals having at least one of different channel processing capabilities or different signal processing capabilities.

In some examples, the downlink control information is configured to indicate the terminal to send the acknowledge feedback according to feedback time indicated in the downlink control information.

The feedback time is greater than the minimum feedback delay corresponding to the terminal.

In some examples, the terminal includes a first type of terminal and a second type of terminal, where the first type of terminal is at least one of an enhanced reduced capability terminal or a terminal having a relaxed processing capability, and the second type of terminal has no relaxed processing capability; and the minimum feedback delay corresponding to the first type of terminal is greater than the minimum feedback delay corresponding to the second type of terminal in a case where the subcarrier spacing of the physical downlink control channel is the same.

In some examples, the minimum feedback delay corresponding to the first type of terminal is twice the minimum feedback delay corresponding to the second type of terminal in a case where the subcarrier spacing of the physical downlink control channel is the same.

In some examples, the feedback time is configured for the terminal to determine a second number corresponding to the feedback time; and the second number is configured for the terminal to send the acknowledge feedback at a second number of symbol intervals in response to receiving the last symbol of the downlink control information for the semi-persistent scheduling deactivation.

In some examples, the second feedback device 100 for semi-persistent scheduling deactivation includes: a third receiving module (not shown), configured to receive at least one of channel processing capability information or signal processing capability information reported by the terminal; and a determination module (not shown), configured to determine feedback time indicated in the downlink control information according to at least one of the channel processing capability information or the signal processing capability information.

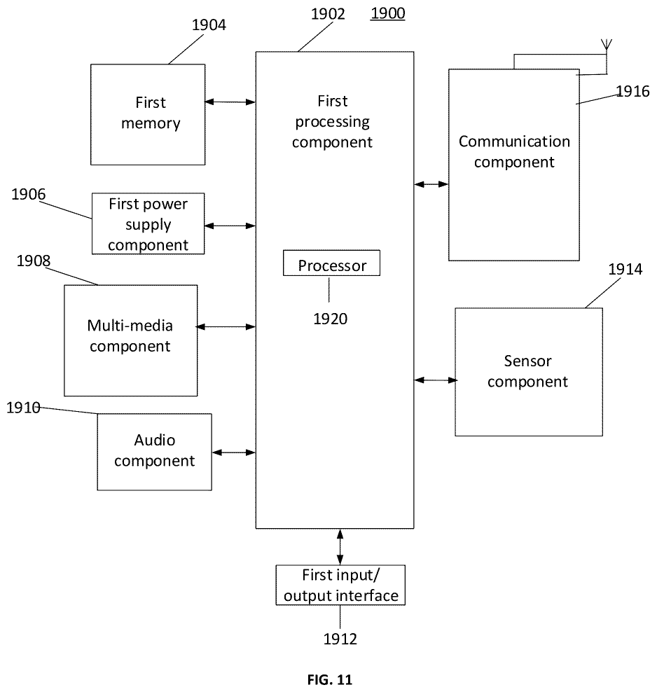

FIG. 11 is a block diagram of a third feedback device 1900 for semi-persistent scheduling deactivation shown according to an example. The third feedback device 1900 for semi-persistent scheduling deactivation may be provided as a terminal. With reference to FIG. 11, the third feedback device 1900 for semi-persistent scheduling deactivation may include at least one of the following components: a first processing component 1902, a first memory 1904, a first power supply component 1906, a multi-media component 1908, an audio component 1910, a first input/output (I/O) interface 1912, a sensor component 1914 and a communication component 1916.

Overall operations of the third feedback device 1900 for semi-persistent scheduling deactivation, such as operations associated with display, phone calls, data communications, camera operations and recording operations, are generally controlled by the first processing component 1902. The first processing component 1902 may include one or more first processors 1920 to execute instructions to complete all or some of steps of the feedback method for semi-persistent scheduling deactivation described above. Further, the first processing component 1902 may include one or more modules that facilitate interaction between the first processing component 1902 and other components. For example, the first processing component 1902 may include a multi-media module, so as to facilitate interaction between the multi-media component 1908 and the first processing component 1902.

The first memory 1904 is configured to store any type of data to support operations at the third feedback device 1900 for semi-persistent scheduling deactivation. Examples of such data include instructions, contact data, phone book data, messages, pictures, videos, etc., for any application or feedback method for semi-persistent scheduling deactivation operated on the third feedback device 1900 for semi-persistent scheduling deactivation. The first memory 1904 may be implemented by any type of volatile or non-volatile storage device, or a combination of any type of volatile or non-volatile storage device, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

Power is provided by the first power supply component 1906 for various components of the third feedback device 1900 for semi-persistent scheduling deactivation. The first power supply component 1906 may include a power management system, one or more power supplies, and other components associated with generation, management and distribution of power for the third feedback device 1900 for semi-persistent scheduling deactivation.

The multi-media component 1908 includes a screen that provides an output interface between the third feedback device 1900 for semi-persistent scheduling deactivation and a user. In some embodiments, a screen may include a liquid crystal display (LCD) and a touch panel (TP). If the screen includes the touch panel, the screen may be implemented as a touch screen to receive an input signal from a user. The touch panel includes one or more touch sensors to sense touch, swipe, and gestures on the touch panel. A boundary of a touch or swiping action may be sensed by the touch sensor, and duration and pressure associated with a touching or swiping operation may be further detected by the touch sensor. In some embodiments, a multi-media component 1908 includes a front-facing camera and/or a rear-facing camera. When the third feedback device 1900 for semi-persistent scheduling deactivation is in an operation mode, such as a photographing mode or a video mode, external multi-media data may be received by the front-facing camera and/or the rear-facing camera. Each front-facing camera and each rear-facing camera may be a fixed optical lens system or have a focal length and an optical zoom capability.

The audio component 1910 is configured to output and/or input an audio signal. For example, the audio component 1910 includes a microphone (MIC). The microphone is configured to receive an external audio signal when the third feedback device 1900 for semi-persistent scheduling deactivation is in an operating mode, such as a call mode, a recording mode, and a voice recognition mode. The received audio signal may be further stored in the first memory 1904 or sent via the communication component 1916. In some embodiments, an audio component 1910 further includes a loudspeaker for outputting an audio signal.

An interface is provided by the first I/O interface 1912 between the first processing component 1902 and a peripheral interface module. The peripheral interface module described above may be a keyboard, a click wheel, a button, etc. The button may include, but not limited to, a home button, a volume button, a start button, and a lock button.

The sensor component 1914 includes one or more sensors used to provide state assessments of various aspects for the third feedback device 1900 for semi-persistent scheduling deactivation. For example, an open/closed state of the third feedback device 1900 for semi-persistent scheduling deactivation, and a relative positioning of components may be detected by the sensor component 1914. For example, the component is a display and a keypad of the third feedback device 1900 for semi-persistent scheduling deactivation. A change in position of the third feedback device 1900 for semi-persistent scheduling deactivation or a component of the third feedback device 1900 for semi-persistent scheduling deactivation, presence or absence of the user making contact with the third feedback device 1900 for semi-persistent scheduling deactivation, orientation or acceleration/deceleration of the third feedback device 1900 for semi-persistent scheduling deactivation, and a change in temperature of the third feedback device 1900 for semi-persistent scheduling deactivation may be further detected by the sensor component 1914. The sensor component 1914 may include a proximity sensor configured to detect presence of nearby objects in the absence of any physical contact. The sensor component 1914 may further include a light sensor, such as a complementary metal-oxide-semiconductor (CMOS) image sensor or a charge coupled device (CCD) image sensor, used in imaging applications. In some embodiments, a sensor component 1914 may further include an acceleration sensor, a gyro sensor, a magnetic sensor, a pressure sensor, or a temperature sensor.

The communication component 1916 is configured to facilitate communication between the third feedback device 1900 for semi-persistent scheduling deactivation and other devices in a wired or wireless manner. A wireless network based on a communication standard, such as wireless fidelity (WiFi), second generation mobile communication (2G), third generation mobile communication (3G), or a combination of the WiFi, the 2G and the 3G, may be accessed by the third feedback device 1900 for semi-persistent scheduling deactivation. In an example, a broadcast signal or broadcast related information from an external broadcast management system is received by a communication component 1916 via a broadcast channel. In an example, a communication component 1916 further includes a near field communication (NFC) module to facilitate short range communication. For example, the NFC module may be implemented based on a radio frequency identification (RFID) technology, an infrared data association (IrDA) technology, an ultra-wide band (UWB) technology, a Bluetooth (BT) technology, and other technologies.

In an example, a third feedback device 1900 for semi-persistent scheduling deactivation may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, micro-processors, or other electronic elements, and is used to perform the feedback method for semi-persistent scheduling deactivation described above.

In an example, a non-transitory computer-readable storage medium including instructions is further provided, such as the first memory 1904 including instructions. The instructions are executable by a processor 1920 of a third feedback device 1900 for semi-persistent scheduling deactivation, so as to complete the method for the semi-persistent scheduling deactivation described above. For example, the non-transitory computer-readable storage medium may be a read-only memory (ROM), a random access memory (RAM), a compact disc read-only memory (CD-ROM), a magnetic tape, a floppy disk, an optical data storage device, etc.

In another example, a computer program product is further provided. The computer program product includes a computer program executable by a programmable device. The computer program has code portions for performing the feedback method for semi-persistent scheduling deactivation described above when executed by the programmable device.

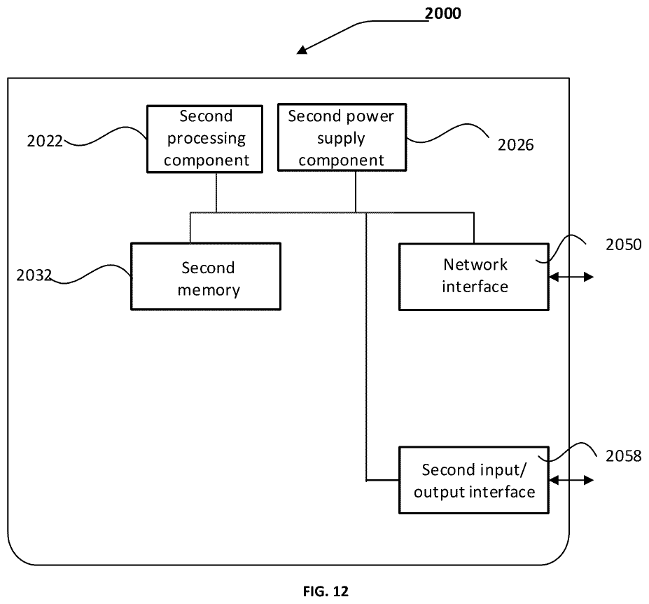

FIG. 12 is a block diagram of a feedback device for semi-persistent scheduling deactivation shown according to an example. For example, a fourth feedback device 2000 for semi-persistent scheduling deactivation may be provided as an access network device, such as a base station. With reference to FIG. 12, the fourth feedback device 2000 for semi-persistent scheduling deactivation includes a second processing component 2022. The second processing component 2022 further includes one or more processors (not shown), and memory resources represented by a second memory 2032, which are used to store instructions, for example, an application, executable by the second processing component 2022. The application stored in the second memory 2032 may include one or more modules, each of which corresponds to a group of instructions. Further, the second processing component 2022 is configured to execute the instructions, so as to perform steps of the feedback method for semi-persistent scheduling deactivation according to any of the method embodiments.

As used herein, the term processor may refer to one processor that performs the defined functions or a plurality of processors that collectively perform defined functions, such that the execution of the individual defined functions may be divided amongst such processors.

The fourth feedback device 2000 for semi-persistent scheduling deactivation may further include a second power supply component 2026 configured to perform power management for the fourth feedback device 2000 for semi-persistent scheduling deactivation, a wired or wireless network interface 2050 configured to connect the fourth feedback device 2000 for semi-persistent scheduling deactivation to a network, and a second input/output (I/O) interface 2058. The fourth feedback device 2000 for the semi-persistent scheduling deactivation may operate an operating system stored in the second memory 2032, such as Windows Server™, Mac OS X™, Unix™, Linux™, FreeBSD™, or the like.

In another example, a computer program product is further provided. The computer program product includes a computer program executable by a programmable device. The computer program has code portions for performing the feedback method for semi-persistent scheduling deactivation described above when executed by the programmable device.

Those skilled in the art easily conceive of other implementation solutions of the present disclosure upon consideration of the description and practice of the present disclosure. The present application is intended to cover any variations, uses or adaptive changes of the present disclosure. The variations, uses or adaptive changes follow the general principles of the present disclosure and include common general knowledge or customary technical means, which is not disclosed in the present disclosure, in the technical field. The description and the embodiments are merely to be regarded as illustrative, and the true scope and spirit of the present disclosure are indicated by the appended claims.

It should be understood that the present disclosure is not limited to a precise structure which has been described above and illustrated in the accompanying drawings, and can have various modifications and changes without departing from the scope of the present disclosure. The scope of the present disclosure is limited by the appended claims merely.

1. A feedback method for semi-persistent scheduling deactivation, performed by a terminal, comprising:
receiving downlink control information for the semi-persistent scheduling deactivation sent by a base station via a physical downlink control channel; and
sending acknowledge feedback after a first number of symbol intervals in response to receiving a last symbol of the downlink control information;,
wherein the first number of symbol intervals is a number of symbols corresponding to a minimum feedback delay of the terminal, and
wherein in a case where a subcarrier spacing of the physical downlink control channel is the same, different minimum feedback delays correspond to terminals having at least one of different channel processing capabilities or different signal processing capabilities.

2. The method according to claim 1, wherein sending the acknowledge feedback after the first number of symbol intervals in response to receiving the last symbol of the downlink control information comprises:
sending the acknowledge feedback according to feedback time indicated in the downlink control information, wherein the feedback time is greater than the minimum feedback delay corresponding to the terminal.

3. The method according to claim 1, wherein
the terminal comprises a first type of terminal and a second type of terminal,
the first type of terminal is at least one of an enhanced reduced capability terminal or a terminal having a relaxed processing capability,
the second type of terminal has no relaxed processing capability,
the minimum feedback delay corresponding to the first type of terminal is greater than the minimum feedback delay corresponding to the second type of terminal in a case where the subcarrier spacing of the physical downlink control channel is the same.

4. The method according to claim 3, wherein the minimum feedback delay corresponding to the first type of terminal is twice the minimum feedback delay corresponding to the second type of terminal, in a case where the subcarrier spacing of the physical downlink control channel is the same.

5. The method according to claim 2, wherein sending the acknowledge feedback according to the feedback time indicated in the downlink control information comprises:
determining a second number of symbols corresponding to the feedback time; and
sending the acknowledge feedback at the second number of symbol intervals in response to receiving the last symbol of the downlink control information for the semi-persistent scheduling deactivation.

6. The method according to claim 2, comprising:
reporting at least one of channel processing capability information or signal processing capability information of the terminal to the base station, wherein the at least one of the channel processing capability information or the signal processing capability information is configured for the base station to determine the feedback time indicated in the downlink control information according to at least one of the channel processing capability information or the signal processing capability information.

7. A feedback method for semi-persistent scheduling deactivation, performed by a base station, comprising:
sending downlink control information for the semi-persistent scheduling deactivation to a terminal via a physical downlink control channel, wherein the downlink control information is configured to indicate the terminal to send acknowledge feedback; and
receiving the acknowledge feedback sent by the terminal, wherein the terminal sends the acknowledge feedback after a first number of symbol intervals in response to receiving a last symbol of the downlink control information;,
wherein the first number of symbol intervals is a number of symbols corresponding to a minimum feedback delay of the terminal, and
wherein in a case where a subcarrier spacing of the physical downlink control channel is the same, different minimum feedback delays correspond to terminals having at least one of different channel processing capabilities or different signal processing capabilities.

8. The method according to claim 7, wherein
the downlink control information is configured to indicate the terminal to send the acknowledge feedback according to feedback time indicated in the downlink control information; and
wherein the feedback time is greater than the minimum feedback delay corresponding to the terminal.

9. The method according to claim 7, wherein
the terminal comprises a first type of terminal and a second type of terminal,
the first type of terminal is at least one of an enhanced reduced capability terminal or a terminal having a relaxed processing capability,
the second type of terminal has no relaxed processing capability; and
the minimum feedback delay corresponding to the first type of terminal is greater than the minimum feedback delay corresponding to the second type of terminal in a case where the subcarrier spacing of the physical downlink control channel is the same.

10. The method according to claim 9, wherein the minimum feedback delay corresponding to the first type of terminal is twice the minimum feedback delay corresponding to the second type of terminal in a case where the subcarrier spacing of the physical downlink control channel is the same.

11. The method according to claim 8, wherein
the feedback time is configured for the terminal to determine a second number corresponding to the feedback time; and
the second number is configured for the terminal to send the acknowledge feedback at the second number of symbol intervals in response to receiving the last symbol of the downlink control information for the semi-persistent scheduling deactivation.

12. The method according to claim 8, comprising:
receiving at least one of channel processing capability information or signal processing capability information reported by the terminal; and
determining the feedback time indicated in the downlink control information according to at least one of the channel processing capability information or the signal processing capability information.

13-14. (canceled)

15. A feedback device for semi-persistent scheduling deactivation, comprising:
one or more processors; and
a memory that stores processor-executable instructions,
wherein the one or more processors are collectively configured to:
receive downlink control information for the semi-persistent scheduling deactivation sent by a base station via a physical downlink control channel; and
send acknowledge feedback after a first number of symbol intervals in response to receiving a last symbol of the downlink control information;
wherein the first number of symbol intervals is a number of symbols corresponding to a minimum feedback delay of the terminal, and
wherein in a case where a subcarrier spacing of the physical downlink control channel is the same, different minimum feedback delays correspond to terminals having at least one of different channel processing capabilities or different signal processing capabilities.

16. A feedback device for semi-persistent scheduling deactivation, comprising:
one or more processors; and
a memory that stores processor-executable instructions,
wherein the one or more processors are collectively configured to perform steps of the method according to claim 7.

17. A non-transitory computer-readable storage medium storing computer program instructions, wherein the program instructions, when executed by one or more processors, implement steps of the method according to claim 1.

18. The feedback device for semi-persistent scheduling deactivation according to claim 15, wherein the one or more processors are further collectively configured to:
send the acknowledge feedback according to feedback time indicated in the downlink control information, wherein the feedback time is greater than the minimum feedback delay corresponding to the terminal.

19. The feedback device for semi-persistent scheduling deactivation according to claim 15, wherein
the terminal comprises a first type of terminal and a second type of terminal,
the first type of terminal is at least one of an enhanced reduced capability terminal or a terminal having a relaxed processing capability,
the second type of terminal has no relaxed processing capability, and
the minimum feedback delay corresponding to the first type of terminal is greater than the minimum feedback delay corresponding to the second type of terminal in a case where the subcarrier spacing of the physical downlink control channel is the same.

20. The feedback device for semi-persistent scheduling deactivation according to claim 19, wherein the minimum feedback delay corresponding to the first type of terminal is twice the minimum feedback delay corresponding to the second type of terminal, in a case where the subcarrier spacing of the physical downlink control channel is the same.

21. The feedback device for semi-persistent scheduling deactivation according to claim 18, wherein the one or more processors are further collectively configured to:
determine a second number of symbols corresponding to the feedback time; and
send the acknowledge feedback at the second number of symbol intervals in response to receiving the last symbol of the downlink control information for the semi-persistent scheduling deactivation.

22. The feedback device for semi-persistent scheduling deactivation according to claim 18, wherein the one or more processors are further collectively configured to:
report at least one of channel processing capability information or signal processing capability information of the terminal to the base station, wherein the at least one of the channel processing capability information or the signal processing capability information is configured for the base station to determine the feedback time indicated in the downlink control information according to at least one of the channel processing capability information or the signal processing capability information.
